(19) United States
(12) Patent Application Publication
(10) Pub. No.: US 2022/0019603 A1
(43) Pub. Date: Jan. 20, 2022

(54) SYSTEMS AND METHODS FOR CLASSIFYING DATA RECEIVED FROM UNKNOWN ENTITIES

(71) Applicant: New Relic, Inc., San Francisco, CA (US)

(72) Inventors: Ashley PULS, San Francisco, CA (US); Melinda CAMPBELL, San Francisco, CA (US); Patrick LIGHTBODY, San Francisco, CA (US); Theodore SCHUH, San Francisco, CA (US)

(21) Appl. No.: 16/929,603

(22) Filed: Jul. 15, 2020

(51) Int. Cl. G06F 16/28

(52) U.S. Cl. CPC G06F 16/285; H04L 41/14; G06F 16/288

(57) ABSTRACT

Systems and method embodying the invention receive an item of telemetry data from an unknown entity and attempt to determine an entity name and entity type for the unknown entity based on the information included in the data item. Also, an entity ID may be generated for the unknown entity. The data item may then be tagged with the entity ID, entity name and entity type before the data item is passed to a recording and storage unit. Also, information about the newly identified entity may be sent to an entity tracking system.

### BACKGROUND OF THE INVENTION

The present application discloses technology which is used to help a business keep a computer-based production environment operating efficiently and with good performance. The “production environment” could be any of many different things. In some instances, the production environment could be a networked system of computer servers that are used to run an online retailing operation. In another instance, the production environment could be a computer system used to generate computer software applications. In still other embodiments, the production environment could be a computer-controlled manufacturing system. Virtually any sort of production environment that relies upon computers, computer software and/or computer networks could benefit from the systems and methods disclosed in this application.

To monitor the status of a production environment, various monitoring elements are installed within the production environment, and those monitoring elements report telemetry data to a production environment analysis system. In some instances, all the monitoring elements will be ones that were created and/or installed by the provider of the production environment analysis system. However, production environments tend to grow over extended periods of time. Different production environment analysis systems may have been installed within the production environment at different times. As a result, the monitoring elements that are installed in a production environment may have been provided in association with multiple different production environment analysis systems.

Also, some production environments are the result of two or more companies merging together. If a first company used a first type of production environment analysis system and a second company used a second type of production environment analysis system, when the two companies merge the merged production environment will have monitoring and reporting elements from both the first and second production environment analysis systems. In many cases, the first production environment analysis system will not be capable of receiving and effectively using the data generated by all of the monitoring and reporting elements provided by the second production environment analysis system, and vice versa. This makes it difficult or impossible to monitor the performance of the entire merged production environment in a unified and comprehensive way with a single production environment analysis system.

Also, some production environment analysis systems utilize proprietary monitoring and reporting elements that are designed to be installed in a client's production environment and to report data about the operations of the production environment to the production environment analysis system. However, it is also possible to install third party and open source monitoring elements into the production environment for various purposes. In many cases, the production environment analysis system will be unable to receive and effectively use the data reported by the third party or open source monitoring elements because the production environment analysis system is designed to receive data only from its own proprietary monitoring elements.

For all the above reasons, it would be desirable for a production environment analysis system provided by a first party to be configured such that the production environment analysis system can receive and effectively utilize data from open source monitoring and reporting elements, or from monitoring and reporting elements that were provided by third parties.

### BRIEF DESCRIPTION OF THE DRAWINGS

FIG. 1 is a diagram of a computer network environment in which systems and methods embodying the invention may be used;

FIG. 2 is a diagram of selected elements of a production environment analysis system embodying the invention;

FIG. 3 is a diagram of selected elements of a data collection and storage unit embodying the invention that would be part of a production environment analysis system;

FIG. 4 is a flowchart illustrating steps of a first method embodying the invention for receiving and storing telemetry data sent from an unknown entity;

FIG. 5 is a flowchart illustrating steps of another method embodying the invention for creating an entity ID for an entity; and

FIG. 6 is a diagram of a computer system and associated peripherals which could embody the invention, or which could be used to practice methods embodying the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

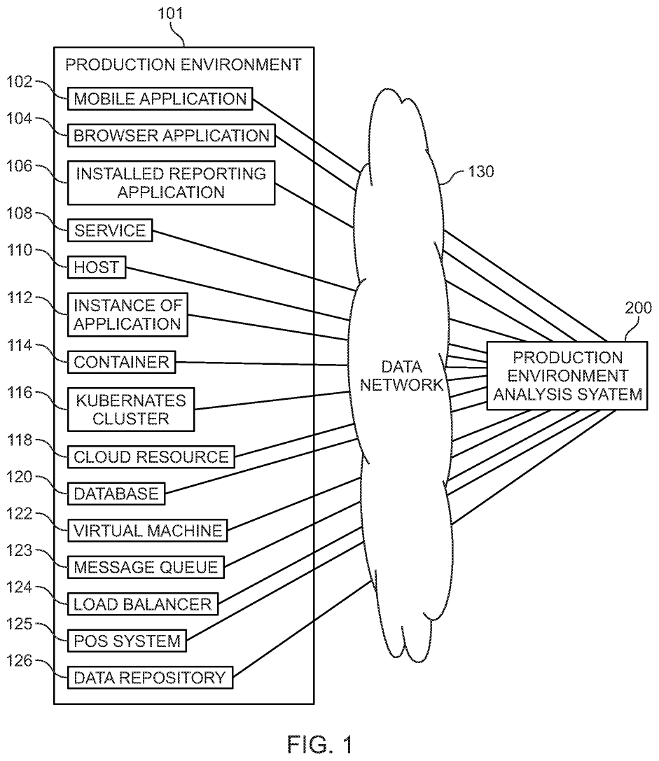

FIG. 1 illustrates a production environment 101 including various entities, and a production environment analysis system 200 that is configured to monitor the condition or status of the production environment 101 based on data received from the entities.

For purposes of the following description, an “entity” can be any element of a production environment. As illustrated in FIG. 1, the entities within a production environment 101 can include mobile applications 102, browser applications 104, an installed reporting application 106 present on a computer or other device, a service 108, a host 110, an instance of a software application 112, a container 114, a Kubernetes cluster 116, a serverless function or cloud resource (also known as a lambda function) 118, a database 120, a virtual machine 122, a message queue 123, a load balancer 124, a point of sale system 125, a data repository 126 or some other device, application or function of a production environment.

Some or all of the entities within a production environment produce telemetry data that is ultimately sent to the production environment analysis system 200 via a data network 130. The data network 130 could include a private data network and/or the Internet. An entity may be designed to generate and report telemetry data, or a monitoring and reporting software application may be installed on or within an entity to report telemetry data to the production environment analysis system 200. A monitoring and reporting software application could be an application programming interface (API) provided by the production environment analysis system. Alternatively, third-party or open source monitoring and reporting software applications could be installed on or within an entity. Generally speaking, the telemetry data indicates when events occur and metrics about various aspects of the production environment. Such data can indicate usage levels, how well an entity is performing and various other performance measures.

As is well known to those of ordinary skill in the art, the telemetry data that is reported to the production environment analysis system 200 generally falls into one of four categories: (1) metrics data; (2) event data; (3) log data; and (4) trace data. Of course, other forms of data may also be reported to the production environment analysis system 200 by one or more entities within a production environment. For example, in some situations telemetry data can include blob data, such as stack trace data.

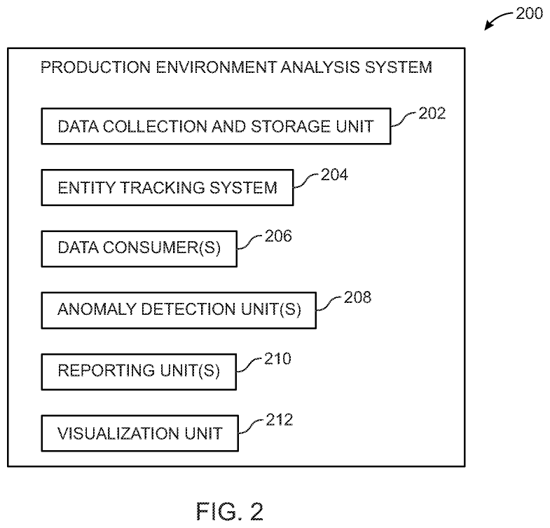

FIG. 2 illustrates some elements of a production environment analysis system 200 embodying the invention. In some embodiments, not all of the elements shown in FIG. 2 would be present. Also, some embodiments of a production environment analysis system would include elements in addition to those shown in FIG. 2. Thus, the depiction in FIG. 2 should in no way be considered limiting of the invention.

The production environment analysis system 200 includes a data collection and storage system 202 that receives and stores telemetry data sent from entities of a production environment. In some instances, the data collection and storage system 202 may also export stored data to various entities. Details about the data collection and storage unit 202 are discussed below.

The production environment analysis system 200 also includes an entity tracking system 204 which stores various items of information about each of the known entities present within a production environment. The information tracked for each entity can include an entity ID, the entity type, the entity name and various other items of information. The entity ID can be encoded in such a way that it includes various items of information about the entity. For example, the entity ID could include information identifying the client account number or name for the production environment in which the entity resides. The entity ID could also include information identifying the domain name, domain type and domain ID in which the entity resides.

The entity tracking system 204 also includes information about the relationships between the various entities that are present in a production environment. The relationship information can be used to generate graphical visualizations of the entities within a production environment to help monitoring personnel understand how the various entities are connected and how they may or may not affect and influence one another. The relationship information can also be used to help diagnose any problems that may be occurring within a production environment, and to identify the root causes of those problems.

As will be explained in more detail below, when the data collection and storage unit 202 of the production environment analysis system 200 receives telemetry data from a new or unknown entity, the data collection and storage unit 202 attempts to identify the entity and to tie certain identifying information to the entity. This can include determining or generating an entity name, an entity type and an entity ID for the new or unknown entity. Any such information that is determined or generated for the new or unknown entity is then reported to the entity tracking system 204, which can update the information it tracks for known entities.

The production environment analysis system 200 also includes one or more data consumers 206. The data consumers 206 analyze the telemetry data received from the entities of a production environment to determine if there are any problems or issues within the production environment. The data consumers 206 may utilize the information in the entity tracking system, such as information about the relationships between the entities, to help diagnose problems within a production environment and to determine the root causes of those problems.

The production environment analysis system 200 further includes one or more anomaly detection units 208 that use information generated by the data consumers to identify any anomalies that may be revealed by the received telemetry data. An anomaly could be an actual problem, or data that does not appear to correspond to what one would anticipate. If an anomaly is identified, one or more reporting units 210 would generate alerts or reports about the anomaly that are sent to one or more monitoring personnel or system technicians.

The production environment analysis system 200 may also include a visualization unit 212 that uses received telemetry data, information or reports generated by the data consumers 206 or the anomaly detection units 208 to generate graphs, maps, charts and other forms of visualizations to help monitoring personnel and system technicians understand what is occurring within a production environment. The visualization unit 212 may also use information in the entity tracking system 204, such as information about relationships between entities, to help generate those visualizations. The visualizations can include graphs, maps and charts and other similar visualization tools.

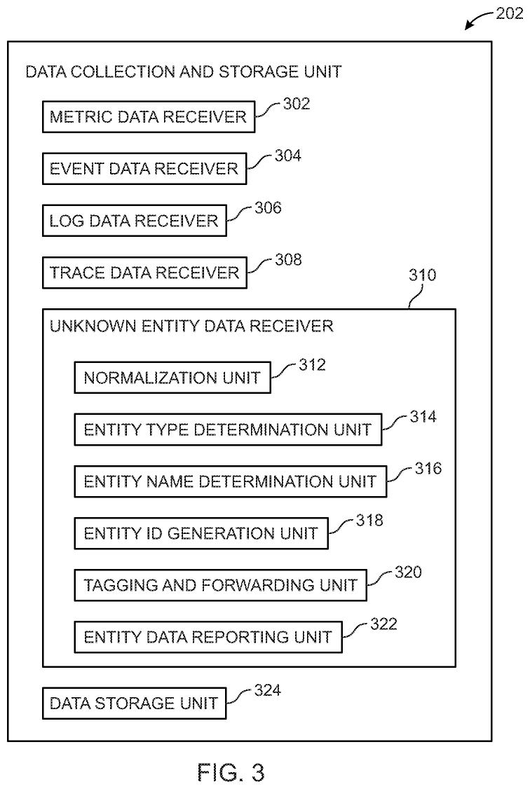

FIG. 3 illustrates elements of a data collection and storage unit 202 embodying the invention. As mentioned above, the data collection and storage unit 202 would receive telemetry data from entities within a production environment, and pass that data on to data consumers 206, as well as store the data in one or more databases, logs and data repositories. In some embodiments, a data collection and storage unit 202 embodying the invention may not include all of the elements illustrated in FIG. 3. Likewise, some data collection and storage units embodying the invention may include elements in addition to those shown in FIG. 3. Thus, the depiction in FIG. 3 should in no way be considered limiting of the invention.

The data collection and storage unit 202 includes a metric data receiver 302 for receiving metric data from known entities, an event data receiver 304 for receiving event data from known entities, a log data receiver 306 for receiving log data from known entities, and a trace data receiver 308 for receiving trace data from known entities. Each of those different types of data have different characteristics and need to be handled in differing fashions. Each of the metric data receiver 302, the event data receiver 304, the log data receiver 306 and the trace data receiver 308 may transform, normalize or otherwise modify received telemetry data depending on the type of data and how the data will be used and analyzed. The received and/or transformed, normalized or modified data is then sent to a data storage unit 324 where it is stored in one or more databases or data repositories. The received and/or transformed, normalized or modified data may also be sent to a data consumer 206 or anomaly detection unit 208 of the production environment analysis system 200 for use in analyzing the operations of the production environment.

As mentioned above in the Background section, one of the challenges of any production environment analysis system is that some entities within a production environment may have data monitoring and reporting elements that came from third-party production environment analysis systems, or which are open source items. This can include entities that are configured to report data to a production environment analysis system that were originally supplied by a third party, or instances where an open source or third-party data reporting API or other form of data reporting software application has been installed in or on an entity within the production environment. In many cases, the telemetry data generated by those entities will not be recognizable by the metric data receiver 302, the event data receiver 304, the log data receiver 306 and the trace data receiver 308 of the data collection and storage unit 202.

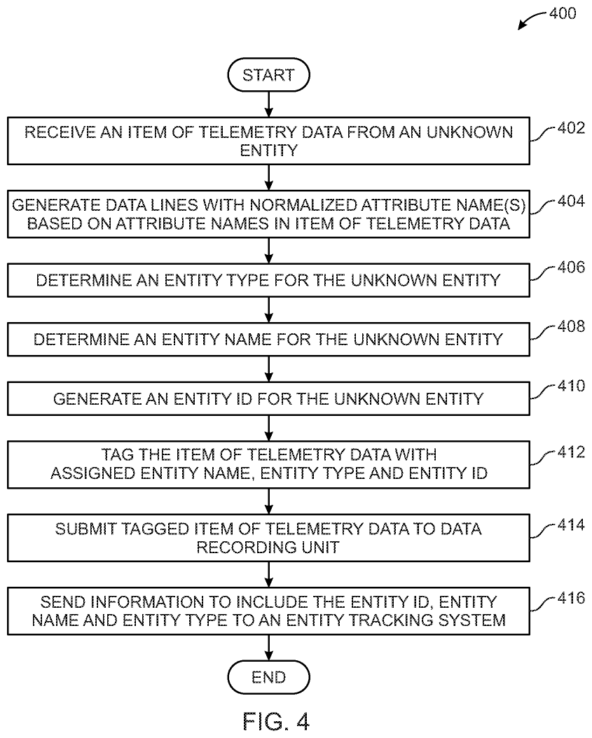

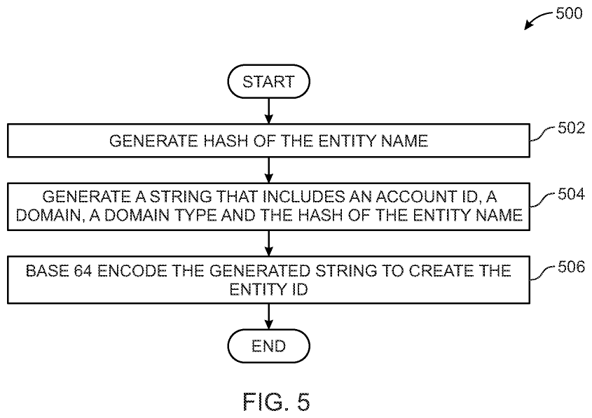

The unknown entity data receiver 310 of the data collection and storage unit 202 is designed to receive and handle telemetry data sent from a new or unknown entity and/or which includes unrecognizable data. The unknown entity data receiver 310 assumes that such telemetry data was sent from a new or unknown entity that is generating unrecognizable data. The unknown entity data receiver 310 then determines or generates identifying information for the new or unknown entity using information in the received telemetry data. In some embodiments, the identifying information can include an entity name, an entity type and an entity ID for the unknown entity. The received telemetry data is then tagged with at least some of the identifying information and the tagged data is sent to the data storage unit 324. Also, identifying information for the new entity such as the entity name, entity type and entity ID is sent to the entity tracking system 204 so that the new entity can be added to the list of known entities present in the production environment. Details of this process are discussed below in connection with the flowcharts illustrated in FIGS. 4 and 5.

The unknown entity data receiver 310 includes a normalization unit 312 that examines the data contained in an item of telemetry data sent from an unknown entity and that attempts to generate normalized data that includes the same basic content, but which is formatted in a fashion used by the production environment analysis system 200. Details regarding generation of normalization data are discussed in detail below.

The unknown entity data receiver 310 also includes an entity type determination unit 314 that attempts to identify the type of the unknown entity that sent an item of telemetry data. This is accomplished using information in the received item of telemetry data. FIG. 1 illustrates many different entity types, but other entity types also exist. Each different type of entity may format an item of telemetry data in different ways depending on the type of the entity, and that information can be used to identify the entity type.

The unknown entity data receiver 310 also includes an entity name determination unit 316 that attempts to determine a name of the unknown entity that sent the item of telemetry data. Although the information in the received item of data may be formatted differently than how similar data is formatted by known entities in the production environment, it is often still possible to obtain a name of the entity using the information present in the data item.

The unknown entity data receiver 310 further includes an entity ID generation unit 318 that generates an entity ID for the unknown entity that sent an item of telemetry data to the production environment analysis system. The entity ID uniquely identifies the entity. As will be explained in more detail below, the entity ID may be generated using the determined entity name, determined entity type as well as other data contained within the received item of telemetry data.

A tagging and forwarding unit 320 of the unknown entity data receiver 310 tags the item of telemetry data with various items of information or data and forwards the tagged item of telemetry data to the data storage unit 324. The tagging and forwarding unit 320 may also send a tagged item of telemetry data to a data consumer 206 or anomaly detection unit 208 of the production environment analysis system 200. The tagged item of telemetry data may be tagged with identity information, which can include the generated entity ID, the determined entity name, and the determined entity type, as well as with various other items of information.

An entity data reporting unit 322 of the unknown entity data receiver 310 reports various items of information about the previously unknown entity to the entity tracking system 204 of the production environment analysis system 200 so that the previously unknown entity can be added to the list of known entities. The reported information can include the generated entity ID, the determined entity name, the determined entity type as well as other information, such as information about relationships that the entity has with other known entities.

With the foregoing as background, we will now discuss a method that involves the unknown entity data receiver 310 receiving an item of telemetry data from an unknown entity. This method will be discussed in connection with the flowchart illustrated in FIG. 4. The method involves determining an entity name and an entity type for the unknown entity and generating an entity ID for the unknown entity. The method also involves tagging the data item with certain items of information and sending the tagged data item to a data storage unit 324. The method further involves sending information about the previously unknown entity to an entity tracking system 204 so that the entity can be added to the list of known entities. Methods embodying the invention can include some or all of these aspects.

The method 400 begins and proceeds to step 402 where the unknown entity data receiver 310 receives an item of telemetry data from an unknown entity. For purposes of this discussion, we will use an example of a data item, and we will explain how information in this data item is used to determine an entity name and an entity type for the unknown entity, and how information in the received data item is used to generate an entity ID for the unknown entity. Thus, for purposes of discussion we will assume that during step 402 the unknown entity data receiver 310 received the following item of telemetry data:

“service_name”: “MyTestService”,

“statusCode”: “200”,

“hostname”: “127.0.0.1”,

“port”: 8081

The method 400 then proceeds to step 404 where the normalization unit 312 of the unknown entity data receiver 310 generates items of normalized information based on the information appearing in the received data item. This assumes that the production environment analysis system has naming conventions that are used by entities when reporting data to the data collection and storage unit 202. This also assumes that certain data in the received data item do not conform to those naming conventions. Step 404 involves the normalization unit 312 using information in the received data item to generate or determine names that confirm to the naming conventions used by the production environment analysis system.

In the present example, we assume that the production environment analysis system uses service names that conform to the pattern “service.name” where the word service is separated from the word name by a period. The normalization unit 312 knows that other production environment analysis systems may use a service naming pattern that reads “serviceName” or “service_name”. In this instance, the example data item includes a line that reads “service_name”: “MyTestService”. Based on the known other ways of encoding the service name, the normalization unit 312 would recognize that the data item was generated by a service called “MyTestService”. As a result, the normalization unit 312 can generate a new normalized line for the data item that reads ““service.name”: “MyTestService”.

In the present example, we assume that the production environment analysis system also uses host names that conform to the pattern “host.hostname” where the word host is separated from the word hostname by a period. The normalization unit 312 knows that other production environment analysis systems may use a host naming pattern that simply reads “host” or “hostname”. In this instance, the example data item includes a line that reads “hostname”: “127.0.0.1”. Based on the known other ways of encoding the host name, the normalization unit would recognize that the data item was generated by a host having a name or IP address of “127.0.0.1”. As a result, the normalization unit 312 can generate a new normalized line for the data item that reads ““host.hostname”: “127.0.0.1”.

Once any attribute names in the item of telemetry data have been normalized, the method proceeds to step 406, where the entity type determination unit 314 determines an entity type for the entity that sent the item of telemetry data. This can be accomplished by reviewing the normalized lines generated in step 404 to see if any of the normalized attribute names correspond to an attribute name for a known entity type. In particular any normalized entity names can be compared to known entity name types to try to determine the entity type of the unknown entity.

For example, under the naming conventions used by the production environment analysis system, a mobile application will have a name that corresponds to the convention “mobile.app.name”. A browser application will have a name that corresponds to the convention “browser.app.name”. A service will have a name that corresponds to the convention “service.name”. A Kubernates cluster will have a name that corresponds to the convention “k8s.cluster.name”. A host will have a name that corresponds to the naming convention “host.hostname”. A database will have a name that corresponds to the naming convention “database.name”.

In reviewing the normalized lines that were created in step 404, the entity type determination unit 314 will see that one of the normalized lines reads “service.name”: “MyTestService”. Based on this match to service entities that use the naming convention “service.name” the entity type determination unit 314 will identify the type of the unknown entity as a service.

When performing step 406, the entity type determination unit 314 may compare the normalized lines generated in step 404 to the known naming conventions of different entity types in a predetermined order until there is a match, or until the normalized lines have been compared to all naming conventions without a match. For example, in preferred embodiments of the invention, the entity type determination unit 314 may compare the normalized lines to the naming conventions in the order: (1) mobile application; (2) browser application; (3) service; (4) Kubernates cluster; (5) host; and (6) database. Of course, in alternate embodiments, the normalized lines could be compared to entity type naming conventions in a different order. Also, in alternate embodiments, the normalized lines could be compared to the additional entity type naming conventions, or fewer entity type naming conventions.

The method then proceeds to step 408 where the entity name determination unit 316 determines a name for the unknown entity. Here again, the entity name determination unit 316 would look to the normalized lines created in step 404 to determine if one of those lines includes a recognized entity name convention. In this case, the entity name determination unit 316 would find that one of the normalized lines is for a service.name that is “MyTestService”. Thus, the entity name for the unknown entity would be determined as “MyTestService.”

The method then proceeds to step 410, where the entity ID generation unit 318 generates an entity ID for the unknown entity based on an entity ID generation convention used by the production environment analysis system 200. As an example, the production environment analysis system could create an entity ID for each recognized entity within a production environment using: (1) an account ID or name for the production environment; (2) a domain name; (3) a domain type; and (4) a domain ID. The domain ID could be a hash of the entity name. Of course, the entity ID also could be a randomly generated entity ID that does not duplicate the entity IDs of any other entities.

Creating an entity ID for the unknown entity can be accomplished using the method illustrated in FIG. 5. Thus, before proceeding with an explanation of the method illustrated in FIG. 4, we will turn to an explanation of the method illustrated in FIG. 5. Note: this method would be performed by the entity ID generation unit 318 as the performance of step 410 in the method illustrated in FIG. 4.

The method 500 would begin and proceed to step 502, where the entity ID generation unit 318 generates a hash of the entity name determined in step 408 of the method illustrated in FIG. 4. The hash of the entity name will be the domain ID used to generate an entity ID for the unknown entity.

Next, the entity ID generation unit 318 generates a text string that includes the 4 items listed above which are used to generate an entity ID: (1) an account ID or name for the production environment; (2) a domain name; (3) a domain type; and (4) a domain ID. As mentioned, the hash created in step 502 will be the fourth item in this text string, serving at the domain ID.

Finally, in step 506 the entity ID generation unit 318 base 64 encodes the text string generated in step 504 to create an entity ID for the unknown entity. For purposes of this explanation, we assume that the encoded string that will be an entity ID reads “12345ABCDEF” The method 500 illustrated in FIG. 5 then ends.

An entity ID for the unknown entity could be created in many different ways, depending on the conventions used by the production environment analysis system 200. The example provided above in connection with FIG. 5 is just one example. For example, the entity ID for a new or unknown entity could be a random ID or hash. However, the entity ID is intended to uniquely identify the new or unknown entity.

Turning back to the method illustrated in FIG. 4, once the entity ID generation unit 318 has generated an entity ID for the unknown entity, the method proceeds to step 412, where a tagging and forwarding unit 320 of the data collection and storage unit 202 tags the received item of telemetry data with the identity information. In some embodiments, the identity information can include the generated entity ID, the determined entity type and the determined entity name. The tagged version of the data item could appear as follows:

“service_name”: “MyTestService”,

“statusCode”: “200”,

“hostname”: “127.0.0.1”,

“port”: 8081

“entity.ID”: “12345ABCDEF”

“entity.type”: “SERVICE”

“entity.name”: “MyTestService”

The method then proceeds to step 414, where the tagging and forwarding unit 320 forwards the tagged data item to the data storage unit 324 for storage in a database or data repository. The tagged data item may also then be used by a data consumer 206 or anomaly detection unit 208, and/or it may be exported to some other data consumer. Because the data item has been tagged with the entity's identity information, the data will later be available to conduct analyses and to generate visualizations that help system administrators understand what is happening within the production environment.

Finally, in step 416 the entity data reporting unit 322 reports information regarding the entity that sent the data item to the entity tracking system 204. This information can include the identity information to include the entity ID, the entity name and the entity type, as well as other information drawn from the data item. The entity tracking system 204 could then establish the entity that sent the data item as a known entity within the production environment. The method 400 then ends.

When a new data item is later received from the same entity, the unknown entity data receiver 310 will again perform the same basic process to generate identity information for the new data item. Because the same metadata will be included in the data item (the same key value pairs), the process will result in generation of the same identity information for the new data item. For example, the entity ID generation unit 318 would generate the same entity ID for the new data item as it generated for a data item previously received from the same entity. Once the new data item is tagged with the newly generated identity information, the new tagged data item is submitted to the data recording unit 324. However, because the entity is already known to the entity tracking system 204, it is not necessary to send any information for the new data item to the entity tracking system 204, as occurred in step 324 of the method illustrated in FIG. 4.

In the method described above, identity information in the form of an entity ID, an entity name and an entity type are reported to the entity tracking system 204. In some embodiments, not all of these items of identity information are reported to the entity tracking system 204. Likewise, in some embodiments additional information about the new or unknown entity is also reported to the entity tracking system 204. For example, key value pairs about the entity, AWS tags and Google cloud labels also may be reported to the entity tracking system 204. Information about a relationship between the new or unknown entity and other entities may also be reported to the entity tracking system 204. Further, to the extent the information is discoverable, an owning team name for the entity and a version of software running on the entity also may be reported to the entity tracking system 204.

The invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

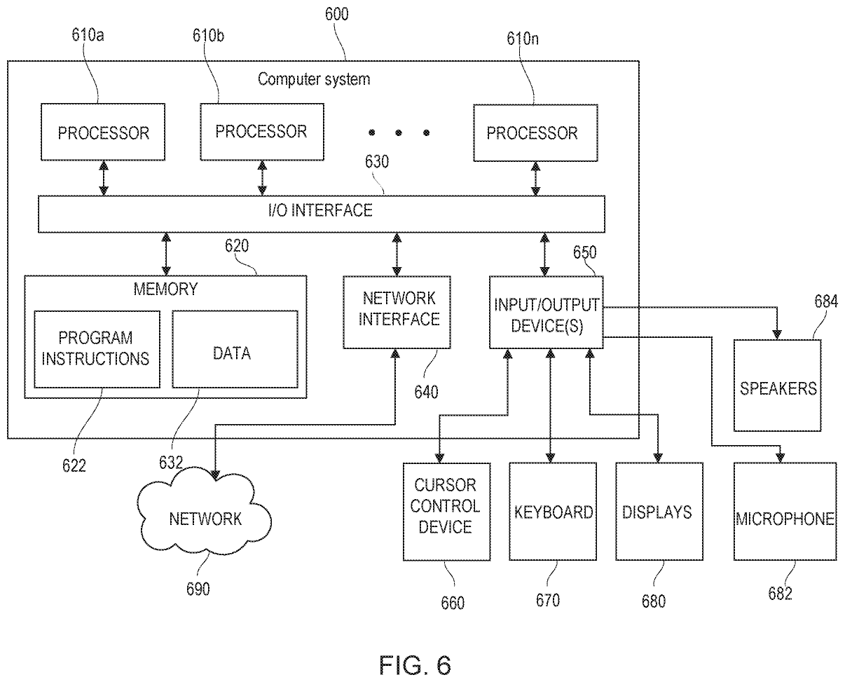

FIG. 6 depicts a computer system 600 that can be utilized in various embodiments of the present invention to implement the invention according to one or more embodiments. The various embodiments as described herein may be executed on one or more computer systems, which may interact with various other devices. One such computer system is the computer system 600 illustrated in FIG. 6. The computer system 600 may be configured to implement the methods described above. The computer system 600 may be used to implement any other system, device, element, functionality or method of the above-described embodiments. In the illustrated embodiments, the computer system 600 may be configured to implement the disclosed methods as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, an input/output devices interface 650. The input/output devices interface 650 facilitates connection of external I/O devices to the system 600, such as cursor control device 660, keyboard 670, display(s) 680, microphone 682 and speakers 684. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, the computer system 600 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices interface 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

External input/output devices interface 650 may, in some embodiments, include one or more display terminals, keyboards, keypads, touchpads, scanning devices, voice or optical recognition devices, or any other devices suitable for entering or accessing data by one or more computer systems 600. Multiple input/output devices may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the operations and methods described above, such as the methods illustrated by the flowcharts of FIGS. 3-5. In other embodiments, different elements and data may be included.

Those skilled in the art will appreciate that the computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

In many of the foregoing descriptions, a software application running on a telephony device may perform certain functions related to the disclosed technology. In alternate embodiments, a browser running on the telephony device may access a software application that is running on some other device via a data network connection. For example, the software application could be running on a remote server that is accessible via a data network connection. The software application running elsewhere, and accessible via a browser on the telephony device may provide all of the same functionality as an application running on the telephony device itself. Thus, any references in the foregoing description and the following claims to an application running on a telephony device are intended to also encompass embodiments and implementations where a browser running on a telephony device accesses a software application running elsewhere via a data network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of processing received telemetry data in connection with monitoring a production environment, comprising:
receiving an item of telemetry data from an unknown entity of a production environment;
assigning an entity type to the unknown entity;
assigning an entity name to the unknown entity;
generating an entity ID for the unknown entity, where the entity ID is based on at least the entity type and the entity name; and
tagging the item of telemetry data with at least the entity ID.

2. The method of claim 1, wherein the method further comprises determining that the item of telemetry data was generated by an unknown entity based on the content of the data item.

3. The method of claim 1, further comprising generating at least one normalized attribute name based on one or more attribute names that are included in the item of telemetry data, wherein the step of assigning an entity type to the unknown entity is based on the at least one normalized attribute name.

4. The method of claim 1, further comprising generating at least one normalized attribute name based on an attribute name that is included in the item of telemetry data, wherein the step of assigning an entity name to the unknown entity is based on the at least one normalized attribute name.

5. The method of claim 1, further comprising generating normalized attribute names based on attribute names that are included in the item of telemetry data, wherein the step of assigning an entity name to the unknown entity is based on a generated normalized attribute name and wherein the step of assigning an entity type to the unknown entity is based on a generated normalized attribute name.

6. The method of claim 1, further comprising submitting the tagged item of telemetry data to a data storage unit.

7. The method of claim 1, wherein the tagging step comprises tagging the item of telemetry data with the entity ID, the entity type and the entity name.

8. The method of claim 7, further comprising submitting the tagged item of telemetry data to a data storage unit.

9. The method of claim 1, further comprising sending information that includes the entity ID, the entity type and the entity name to an entity tracking system for recordation in a database of known entities.

10. The method of claim 1, wherein the entity ID is based on a hash of the entity name.

11. A system for processing received telemetry data in connection with monitoring a production environment, comprising:
means for receiving an item of telemetry data from an unknown entity of a production environment;
means for assigning an entity type to the unknown entity;
means for assigning an entity name to the unknown entity;
means for generating an entity ID for the unknown entity, where the entity ID is based on at least the entity type and the entity name; and
means for tagging the item of telemetry data with at least the entity ID.

12. A system for processing received telemetry data in connection with monitoring a production environment, comprising:
a computer or server comprising one or more processors that are running software that configures the one or more processors to perform a method comprising:
receiving an item of telemetry data from an unknown entity of a production environment;
assigning an entity type to the unknown entity;
assigning an entity name to the unknown entity;
generating an entity ID for the unknown entity, where the entity ID is based on at least the entity type and the entity name; and
tagging the item of telemetry data with at least the entity ID.

13. The system of claim 12, where method performed by the one or more processors further comprises determining that the item of telemetry data was generated by an unknown entity based on the content of the data item.

14. The system of claim 12, where method performed by the one or more processors further comprises generating at least one normalized attribute name based on one or more attribute names that are included in the item of telemetry data, wherein the step of assigning an entity type to the unknown entity is based on the at least one normalized attribute name.

15. The system of claim 12, where method performed by the one or more processors further comprises generating at least one normalized attribute name based on an attribute name that is included in the item of telemetry data, and wherein the step of assigning an entity name to the unknown entity is based on the at least one normalized attribute name.

16. The system of claim 12, where method performed by the one or more processors further comprises generating normalized attribute names based on attribute names that are included in the item of telemetry data, wherein the step of assigning an entity name to the unknown entity is based on a generated normalized attribute name and wherein the step of assigning an entity type to the unknown entity is based on a generated normalized attribute name.

17. The system of claim 12, where method performed by the one or more processors further comprises submitting the tagged item of telemetry data to a data storage unit.

18. The system of claim 12, wherein the tagging step comprises tagging the item of telemetry data with the entity ID, the entity type and the entity name.

19. The system of claim 18, where method performed by the one or more processors further comprises submitting the tagged item of telemetry data to a data storage unit.

20. The system of claim 12, where method performed by the one or more processors further comprises sending information that includes the entity ID, the entity type and the entity name to an entity tracking system for recordation in a database of known entities.

21. The system of claim 12, wherein the entity ID is based on a hash of the entity name.
